(19) United States
(12) Patent Application Publication
(10) Pub. No.: US 2015/0276192 A1
(43) Pub. Date: Oct. 1, 2015

(54) SYSTEM AND METHOD OF CONTROLLING STREET LIGHTS

(71) Applicant: Telematics Wireless Ltd., Holon (IL)

(72) Inventors: Eddy KAFRY, Hod Hasharon (IL); Roman STERNBERG, Magshimim (IL)

(21) Appl. No.: 14/666,330

(22) Filed: Mar. 24, 2015

Related U.S. Application Data
(60) Provisional application No. 61/970,372, filed on Mar. 26, 2014.

(51) Int. Cl. F21V 23/00; F21V 15/01; H05B 37/02; F21S 8/08

(52) U.S. Cl. CPC F21V 23/003; F21S 8/085; F21V 15/01; H05B 37/0272; F21W 2131/103

(57) ABSTRACT

An apparatus includes a sleeve for housing at least an antenna of a wireless street lighting control unit and a RF (radio frequency) window. The sleeve is connectable between a luminaire and a lamp pole. The RF window is for said antenna. Alternatively, the antenna is installed externally on top of the sleeve.

### CROSS-REFERENCE TO RELATED APPLICATIONS

This application claims priority and benefit from U.S. Provisional Patent Application No. 61/970,372, filed Mar. 26, 2014, which is hereby incorporated in its entirety by reference.

### FIELD OF THE INVENTION

The present invention relates to street lights generally and to wireless control of street lights in particular.

### BACKGROUND OF THE INVENTION

The history of streetlights dates back to Roman and Greek civilization where street lights were used primarily for security, both to protect the wanderer from tripping over something on the path as well as keeping the potential robbers at bay. Over the years, street lighting has progressed with technology from the use of oil, then gas to arc lamps and incandescent lighting to today's use of as LED (light emitting diodes) and induction lights.

Street lighting, one of the most essential services provided by municipal authorities, is a cost and management challenge. New technological advances can deliver up to 80% reductions in energy usage. Smart control, including proactive maintenance, can slash annual operating costs significantly.

The T-Light system, commercially available from Telematics Wireless Ltd. of Israel, enables utilities and maintenance companies to benefit from an improved level of cost-effective, reliable and timely service, by controlling and managing the operation of each street light. The T-Light system comprises a Smart Street Lighting controlling system which establishes a wireless network between all participating luminaires and provides the operator with a web-accessed, efficient, automatic or manual, control of each light pole's operation. The controlling system may also be applied to lamp poles which already have, or can have, a wired connection.

### SUMMARY OF THE INVENTION

There is therefore provided, in accordance with a preferred embodiment of the present invention, an apparatus including a sleeve and an RF (radio frequency) window. The sleeve houses at least an antenna of a wireless street lighting control unit and is connectable between a luminaire and a lamp pole. The RF window is for the antenna.

Moreover, in accordance with a preferred embodiment of the present invention, the RF window is translucent.

Further, in accordance with a preferred embodiment of the present invention, the apparatus also houses a wireless lighting control unit.

There is also provided, in accordance with a preferred embodiment of the present invention, a sleeve for wireless lighting control unit. The sleeve includes a tube, connection elements, matching the elements connecting a luminaire to a lamp pole, and an RF window. The connection elements connect at least the tube to one of the luminaire and the lamp. The RF window is for an antenna of a street light controller which controls the luminaire.

There is also provided, in accordance with a preferred embodiment of the present invention, a sleeve for installation of at least an RF antenna of a wireless street lighting control unit. The sleeve is connectable between a street lamp (luminaire) and a lamp pole and the antenna is installed externally on top of the sleeve.

Furthermore, in accordance with a preferred embodiment of the present invention, the sleeve also houses a wireless lighting control unit.

There is also provided, in accordance with a preferred embodiment of the present invention, a sleeve for a wireless lighting control unit. The sleeve includes a tube, connection elements, and an RF antenna. The connection elements match the elements connecting a luminaire to a lamp pole and connect the tube to one of the luminaire and the lamp. The RF antenna is mounted externally on top of the sleeve. The antenna is connectable to a street light controller which is connectable to the luminaire.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1B are schematic illustrations of different installations of a prior art luminaire with a wireless control device attached to lamp pole.

FIGS. 2A and 2B are schematic illustrations of an add-on wireless controller for a luminaire, constructed and operative in accordance with a preferred embodiment of the present invention; and

FIG. 3 is a schematic illustration of the elements of the add-on wireless controller of FIGS. 2A and 2B, constructed and operative in accordance with a preferred embodiment of the present invention; and

FIG. 4 is a schematic illustration of an alternative embodiment to the elements of the add-on wireless controller of FIGS. 2A and 2B, constructed and operative in accordance with a preferred embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that upgrading existing street light systems to operate with an individual wireless controller can potentially be an expensive and time consuming activity, especially in cases where the wireless controller must be placed inside of the street lamp's light element, known as a ‘luminaire’. The luminaire may not have been designed to hold additional elements therein and therefore, it may be time consuming to fit the controller into the luminaire.

Moreover, providing space for an antenna for the wireless operation of the controller on top of the luminaire may change the aesthetics of the luminaire as well as jeopardize its waterproof features. This may be particularly true when trying to add such a street light controller to street lights that may have been constructed years ago. Applicants have also realized that the character and authenticity of the street lights may be lost when upgrading old fashioned styled street lights to include modern day control.

An alternative installation of a wireless controller on top of the luminaire, in addition to aesthetic disadvantage, may also require an adaptation of the luminaire in order to accept such on-top addition which also makes it more expensive and less waterproof.

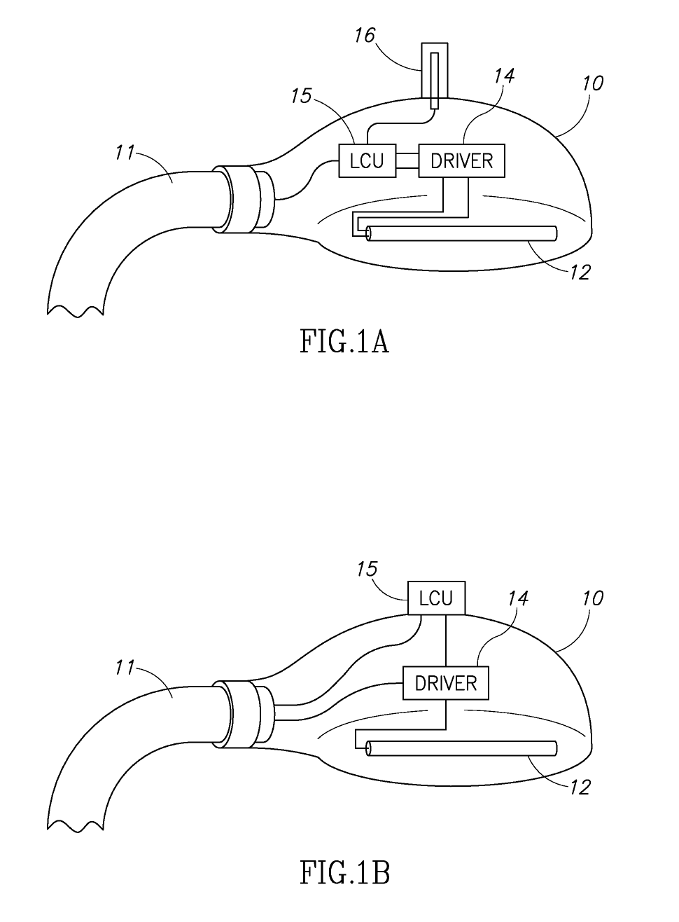

This is shown in FIG. 1A, to which reference is now made. FIG. 1A shows a prior art luminaire 10 on a lamp pole 11, with a light bulb 12 and a light driver or electronic ballast 14 representing the main elements of an uncontrolled luminaire. For a wireless operation, a wireless light controlling unit (LCU) 15 may be added together with an antenna 16. It will be appreciated that antenna 16 is located externally to luminaire 10, which may require holes to be drilled through the external surface of luminaire 10. Light controlling unit 15 may provide instructions to driver 14 as per instructions received via antenna 16.

Reference is now made to FIG. 1B which illustrates an alternative prior art installation of light control unit 15 as a separate device on top of the luminaire. In this embodiment, antenna 18 may be integrated within light control unit 15. It will be appreciated that the installment of light control unit 15 on top of the luminaire 10 may also require drilling holes or the preparation of special adaptors by the Luminaire manufacturer to enable the mounting of light control unit

Applicants have further realized that a wireless controller within an add-on housing or packaging that do not require any modification of the pertinent luminaire nor has any impact on original luminaire integrity and shape may solve the problems indicated herein above.

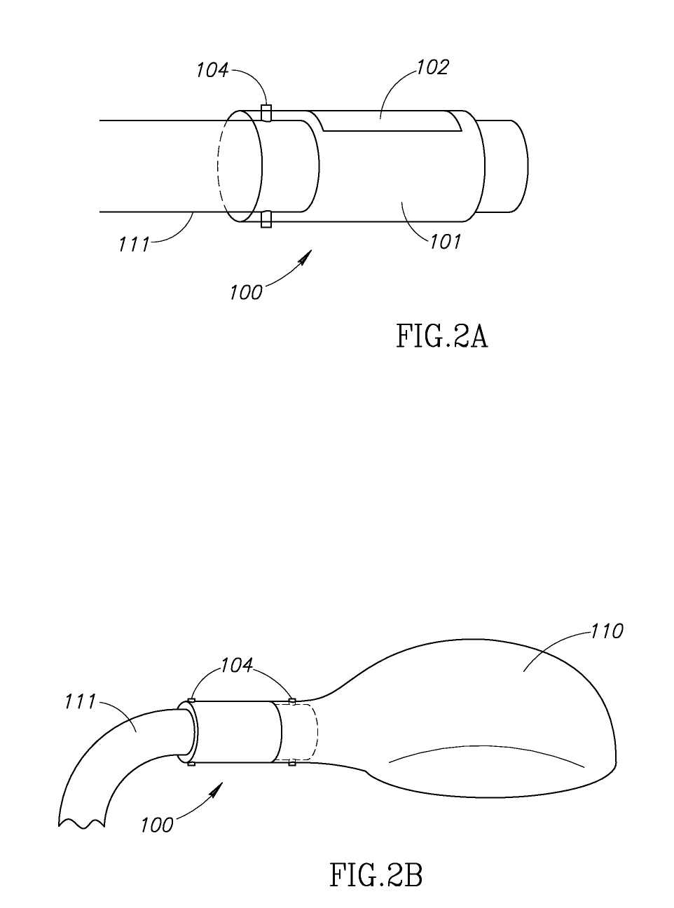

Reference is now made to FIG. 2A which illustrates an add-on controller 100 and FIG. 2B which illustrates its addition to an existing luminaire, constructed in accordance with one of the embodiments of the present invention. Add-on controller 100 may comprise a sleeve 101 to house the components of a wireless light control unit. Sleeve 101 may be of strong metal construction and may comprise at least one RF (radio frequency) window 102, formed of any suitable electromagnetically translucent material (e.g. plastic), through which a wireless light control unit may communicate. Add-on controller 100 may also have connection elements 104 to connect sleeve 101 between the lamp pole, labeled 111, and the luminaire, labeled 110 as is illustrated in FIG. 2B.

It will be appreciated that connection elements 104, such as screws and tacks, may match the original mechanical elements for connecting luminaire 110 to lamp pole 111. Thus, controller 100 may be placed between luminaire 110 and lamp pole 111 without requiring any mechanical changes to luminaire 110 or to lamp pole 111.

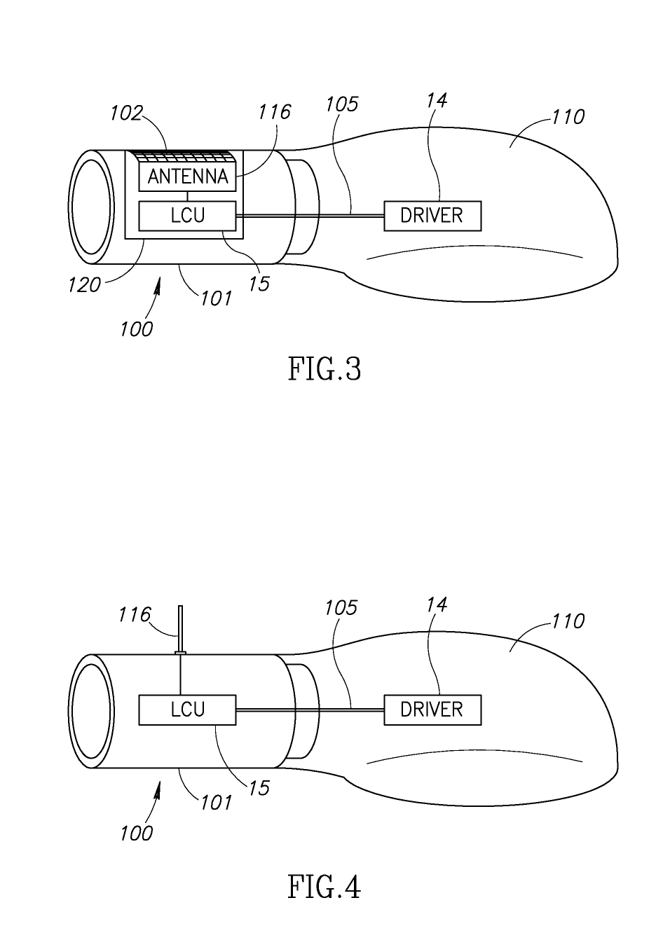

As mentioned above and as shown in FIG. 3 to which reference is now made, sleeve 101 may house a wireless light unit 120, which, in this embodiment, may comprise a wireless light control unit 15 and an antenna 116. In accordance with a preferred embodiment of the present invention, antenna 116 is housed within sleeve 101 and may communicate through window 102. Thus, add-on controller 100 may have no influence on the configuration, form factor and integrity of the luminaire as described herein above.

In an alternative embodiment of present invention as referenced in FIG. 4 to which reference is now made, antenna 116 may be installed externally to sleeve 101, such as on top of it. In this embodiment, sleeve 101 may not include RF window 102 but may be made of a single material which may reduce its cost. It will be appreciated that in this embodiment, the installation of antenna 116 may be made during the manufacturing process with all the proper precautions to preserve the waterproof features of sleeve 101.

As mentioned hereinabove, sleeve 101 may be formed of any suitably strong metal to withstand the forces on the pole and luminaire. It will be appreciated that the wiring 105 within sleeve 101 may be designed to pass electrical power from lamp pole 111 as well as the control wires to luminaire 110 to be connected to the lamp driver inside the luminaire.

Sleeve 101 may be relative short to maintain the original aesthetics of the lamp. In an alternative embodiment, sleeve 101 may only house antenna 116 while the other elements of wireless light unit 120 may be housed within luminaire 110 or within the pole 111.

It will be appreciated that add-on controller 100 may be very easy to install, requiring an installer to disconnect luminaire 110 from lamp pole 111, to connect controller 100 to luminaire 110 using the existing mechanical connecting elements 104 (FIG. 2B), to connect the elements electrically, and then to connect controller 100 with already attached luminaire 110 to lamp pole 111 using the mechanical connections identical to the existing connections 104. As can be seen, there is no need to find space for the wireless controller elements nor ruin the aesthetics of the luminaire by drilling a hole for the antenna or adding the whole controlling device on top of the luminaire.

In an alternative embodiment, the abovementioned procedure may also be applied to a new luminaire before it is installed on lamp pole 111.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An apparatus comprising:
a sleeve for housing at least an antenna of a wireless street lighting control unit, said sleeve connectable between a luminaire and a lamp pole; and
an RF (radio frequency) window for said antenna.

2. The apparatus according to claim 1 and wherein said RF window is translucent.

3. The apparatus according to claim 1 and also housing a wireless lighting control unit.

4. A sleeve for a wireless lighting control unit, the sleeve comprising:
a tube;
connection elements, matching the elements connecting a luminaire to a lamp pole, to connect at least said tube to one of said luminaire and said lamp; and
an RF (radio frequency) window for an antenna of a street light controller, said street light controller to control said luminaire.

5. A sleeve for installation of at least an RF (radio frequency) antenna of a wireless street lighting control unit, said sleeve connectable between a street lamp (luminaire) and a lamp pole; and wherein said antenna is installed externally on top of said sleeve.

6. The sleeve according to claim 4 and also housing a wireless lighting control unit.

7. The sleeve according to claim 5 and also housing a wireless lighting control unit.

8. A sleeve for wireless lighting control unit, the sleeve comprising:
a tube;
connection elements, matching the elements connecting a luminaire to a lamp pole, to connect said tube to one of said luminaire and said lamp; and
an RF (radio frequency) antenna mounted externally on top of the said sleeve, said antenna connectable to a street light controller which is connectable to said luminaire.
